(19) United States
(12) Patent Application Publication
(10) Pub. No.: US 2015/0248733 A1
(43) Pub. Date: Sep. 3, 2015

(54) SYSTEM AND METHOD FOR CATALOGING AND MANAGING PURCHASE ACTIVITY DATA

(71) Applicant: Tisha Evans, Woonsocket, RI (US)

(72) Inventor: Tisha Evans, Woonsocket, RI (US)

(21) Appl. No.: 14/194,739

(22) Filed: Mar. 2, 2014

(51) Int. Cl. G06Q 40/00; G06F 17/30

(52) U.S. Cl. CPC G06Q 40/12; G06F 17/30115

(57) ABSTRACT

A financial data management system and method for allowing a user store receipt data in a centralized database with receipt line items in embodied as discrete entries. The financial data management method comprises the steps of receiving on a smart phone adapted to configure purchase receipt data files either a generated image file, a generated data file, or a transmitted data file containing the typical information on a conventional paper receipt. The purchase receipt data file is then processed by assigning it a unique identifier, extracting line items into discrete receipt entries, and tagging the receipt entries with the general receipt information taken from the source receipt, such as date and store name. The tagged entries are then transmitted to a server which allows the receipt entries to be accessed and manipulated from any device having an Internet connection.

### BACKGROUND OF THE INVENTION

1. Field of the Invention

This invention relates generally to mobile device applications and, more particularly, to a system and method implemented through a mobile device for cataloging and managing data relating to consumer purchases.

2. Description of the Prior Art

It is well established that through the use of electronic data management tools, the manner in which budgets and personal finances can be managed can be improved. Such improvements can include increased accuracy in records and the ability to employ various analyzing tools. A problem which still exists, however, is that manually entering entries from receipts in order to log and/or track expenses can be very tedious and time consuming. Moreover, such manual invites user error into the process, whereby even small errors made while manually typing line item entries can undermine an entire tracking and analysis process. Thus, there remains a need for a system and method which can allow a user to automatically upload and store receipts so as to enable the tracking of discrete expense entries. It would be helpful if such a financial data management system and method could be linked to a user's credit card, debit card, or other charge card (collectively referred to as credit card) and automatically retrieve purchase data from the respective financial institution (also referred to as a banking or credit card institution). It would be additionally desirable for such a financial data management system and method was allowed stored data to be reviewed from an application or browsing software on any electronic device having computing capability.

The Applicant's invention described herein provides for a system and method which allows receipts and purchase data to be automatically stored, cataloged, and managed in electronic form. The primary steps of Applicant's financial data management system and method are retrieving receipt data, extracting retrieved receipt data, and transmitting extracted receipt data to a remote server and/or cloud database. When in operation, the financial data management system and method allows a user to store purchase receipt data in a centralized, network accessible location and track, analyze and export such data from any networked electronic device having computing capability. As a result, many of the limitations imposed by prior art purchase tracking methods are removed.

### SUMMARY OF THE INVENTION

A financial data management system and method for allowing a user store receipt data in a centralized database with receipt line items in embodied as discrete entries. The financial data management method comprises the steps of receiving on a smart phone adapted to configure purchase receipt data files either a generated image file, a generated data file, or a transmitted data file containing the typical information on a conventional paper receipt. The purchase receipt data file is then processed by assigning it a unique identifier, extracting line items into discrete receipt entries, and tagging the receipt entries with the general receipt information taken from the source receipt, such as date and store name. The tagged entries are then transmitted to a server and/or cloud storage which allows the receipt entries to be accessed and manipulated from any device having an Internet connection.

It is an object of this invention to provide a system and method which can allow a user to automatically upload and store receipts so as to enable the tracking of discrete expense entries.

It is another object of this invention to provide a financial data management system and method which can be linked to a user's credit cards and automatically retrieve purchase data from the respective financial institution.

It is yet another object of this invention to provide a financial data management system and method which allows stored data to be reviewed from an application or browsing software on any electronic device having computing capability.

It is still another object of this invention to upload the receipt data to the server and/or cloud without printing a paper receipt in the store.

These and other objects will be apparent to one of skill in the art.

### BRIEF DESCRIPTION OF THE DRAWINGS

FIG. 1 the process flow of the components of a financial data management system and method in accordance with the present invention.

FIG. 2 shows the data configuration process of a financial data management system and method in accordance with the present invention.

### DETAILED DESCRIPTION OF THE INVENTION

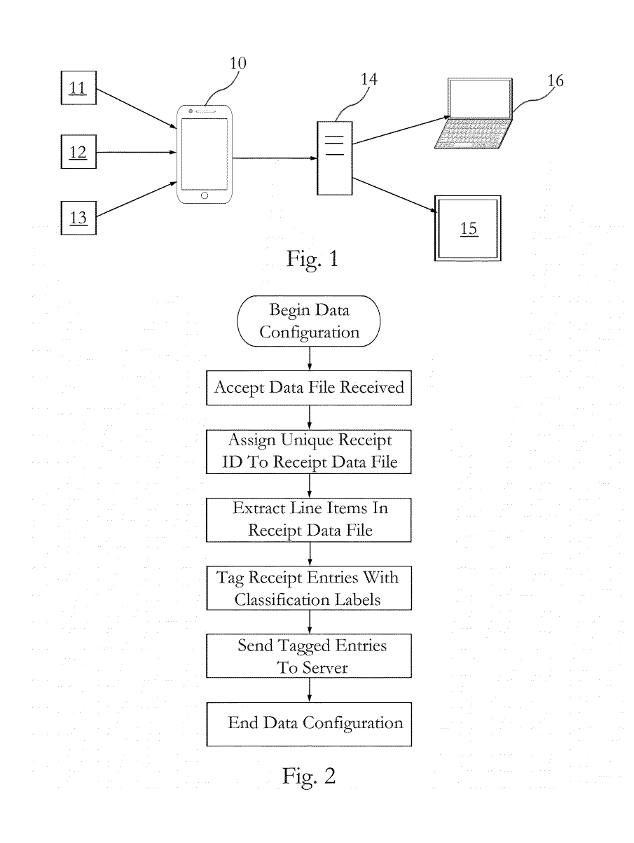

Referring now to the drawings and in particular FIG. 1, the process flow of a financial data management system and method begins with the provision of purchase receipt details, embodied as a purchase receipt data file (or “receipt data”), to a remote personal device adapted to configured receipt data. The remote personal device is adapted to configure receipt data in accordance with the present invention through the installation of a receipt data configuration software application, which performs the steps shown in FIG. 2, infra. The remote personal device can be substantially any computer device, including without limitation personal computers (such as laptop or desktop computers) or mobile devices (such as mobile phones and tablets), which is capable of running software programs, communicating electronic data over a computer network, processing electronic data, and providing a user interface for electronic data. In the preferred embodiment, a smart phone 10 with the receipt data configuration software application installed thereon defines the remote personal device.

In the preferred embodiment, receipt data is provided to the smart phone 10 through either a generated image file 11, a generated data file 12, or a transmitted data file 13. The generated image file 11 is defined by a picture of a conventional paper receipt, typically taken by the smart phone 10. The receipt data configuration software application includes optical character recognition components which allow it to electronically convert the text on the paper receipt to machine-encoded text. The generated data file 12 is an electronic file which is created using the receipt data configuration software application or other text entry software on the smart phone 10. The generated data file 12 embodies the contents of a paper receipt which have been manually entered by a user using a text entry software function. The contents include the substantive information customarily contained on paper receipts, including date of purchase, store name, purchased item identification, purchased item price, tax, and total amount paid.

The transmitted data file 13 is an electronic data file containing the customary contents of a paper receipt which is automatically sent electronically by the issuer of the credit card, debit card, or other charge card (collectively referred to as credit card) to the smart phone 10. This automatically sent electronic receipt function can be availed when a user registers her credit card with the smart phone 10 having the receipt data configuration software application installed thereon and the registration is verified by the issuer of the credit card. When it is availed, a user at the point of sale can optionally decline to receive a paper receipt.

The receipt data configuration software application then performs a data configuration process through which it processes the receipt data and causes the smart phone 10 to send over an electronic data network the processed receipt data to a server 14. The server 14 stores the processed receipt data and avails it to remote personal devices, such as a tablet 15 or a laptop 16, over an electronic data network defined as a computer network. In the preferred embodiment, this computer network is the Internet. In this regard, a user can use a tablet 15 and/or a laptop 16 to access receipt data relating to that user's prior past purchases from anywhere and on any device which can access the Internet.

Referring now to FIG. 2, the data configuration process begins when receipt data is received by the smart phone having receipt data configuration software application installed thereon. While the purchase receipt data file will relate to one discrete purchase receipt, it is appreciated that the receipt data configuration software application can and will process more than one purchase receipt separately. The purchase receipt data file is then assigned a unique receipt identifier to enable the contents of the purchase receipt to forever be associated whether or not they are in the same file or database.

The data configuration process continues through the extraction of desired information from the purchase receipt. The date of purchase, store name, tax, and total amount paid are extracted from the purchase receipt data file as a whole and the purchased item identification and purchased item price is extracted for each purchase line item in the purchase receipt data file. The extracted purchase line item information is then converted into a discrete receipt entry, and each receipt entry is tagged with classification labels to permanently associate the receipt identifier, date of purchase, store name, tax, and total amount paid from the purchase receipt data file with receipt entry. In this regard, all receipt entries can be kept in a single database as well as copied and moved to different budget tables, and still be able to be viewed with all of its original purchase receipt information. The tagged data entries for the processed purchase receipt data file are then sent to the server and/or cloud storage for storage and to be available to the user in the future.

It is contemplated that in order to provide security in handling a plurality of user's receipt entries, the server is equipped with conventional user verification functions.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A financial data management method, comprising the steps of:
providing a remote personal device having a processor and memory, wherein said remote personal device includes a receipt data configuration software application operatively associated therewith sufficient to provide instructions to the processor;
receiving by said remote personal device a purchase receipt data file;
extracting by said remote personal device line items from the purchase receipt data file;
generating by said remote personal device discrete receipt entries from each line item; and
transmitting by said remote personal device receipt entries to a remote server over an electronic data network.

2. The financial data management method of claim 1, additionally comprising the steps of:
assigning by said remote personal device a unique identifier to the purchase receipt data file; and
extracting by said remote personal device date of purchase, store name, tax, and total amount paid from the purchase receipt data file.

3. The financial data management method of claim 2, additionally comprising the step of tagging by said remote personal device each receipt entry with the receipt identifier, date of purchase, and store name extracted from the purchase receipt data file which was the source of the receipt entry being tagged.

4. The financial data management method of claim 1, wherein each of said line items from the purchase receipt data file include purchased item identification and purchased item price.

5. The financial data management method of claim 1, wherein said receipt data configuration software application is embodied on said memory.

6. A financial data management system, comprising:
a remote personal device having a processor and memory, wherein said remote personal device includes a receipt data configuration software application operatively associated therewith sufficient to provide instructions to the processor to configure the remote personal device to:
receive a purchase receipt data file;
extract line items from the purchase receipt data file;
generate discrete receipt entries from each line item; and
transmit receipt entries to a remote server over an electronic data network.

7. The financial data management system of claim 6, wherein said receipt data configuration software application additionally configures the remote personal device to:
assign a unique identifier to the purchase receipt data file; and
extract date of purchase, store name, tax, and total amount paid from the purchase receipt data file.

8. The financial data management system of claim 7, wherein said receipt data configuration software application additionally configures the remote personal device to tag each receipt entry with the receipt identifier, date of purchase, and store name extracted from the purchase receipt data file which was the source of the receipt entry being tagged.

9. The financial data management system of claim 6, wherein each of said line items from the purchase receipt data file include purchased item identification and purchased item price.

10. The financial data management system of claim 6, wherein said receipt data configuration software application is embodied on said memory.
